(19) United States
(12) Patent Application Publication
(10) Pub. No.: US 2019/0047348 A1
(43) Pub. Date: Feb. 14, 2019

(54) METHOD AND ADJUSTMENT SYSTEM FOR KEEPING A VEHICLE ON COURSE DURING ROLL MOVEMENTS OF A VEHICLE BODY

(71) Applicant: AUDI AG, Ingolstadt (DE)

(72) Inventors: Adrian MIHAILESCU, Ingolstadt (DE); Martin ENNING, Ingolstadt (DE); Christian WIEDENMANN, Ingolstadt (DE); Christoph GÖHRLE, Ingolstadt (DE); Tobias TEMPLER, Eichstatt (DE)

(73) Assignee: AUDI AG, Ingolstadt (DE)

(21) Appl. No.: 16/036,231

(22) Filed: Jul. 16, 2018

(30) Foreign Application Priority Data
Aug. 8, 2017 (DE) 10 2017 213 750.9

(51) Int. Cl. B60G 17/0195; B60W 30/045; B60W 10/22; B60W 10/20; B60G 17/016

(52) U.S. Cl. CPC B60G 17/0195; B60W 2520/125; B60W 10/22; B60W 10/20; B60G 17/0162; B60G 2800/94; B60G 2800/9122; B60G 2800/9123; B60G 2800/965; B60G 2400/104; B60G 2400/0513; B60G 2500/40; B60G 2600/182; B60G 2800/012; B60W 2520/14; B60W 30/045

(57) ABSTRACT

A method for keeping a vehicle on course by determining a lateral acceleration of the vehicle; establishing a desired lateral inclination of the vehicle depending on the lateral acceleration determined in step a); adjustment of at least one actuator of an active chassis device of the vehicle, so the vehicle takes on the desired lateral inclination determined in step b); and c) carrying out a compensatory engagement by adjustment of at least one actuator of an active chassis device of the vehicle, so the vehicle takes on the desired lateral inclination determined in step b), wherein, in step d), at least one additional compensatory engagement is carried out by an additional active chassis device for the at least partial compensation of a yaw movement of the vehicle caused by the adjustment of the at least one actuator of the active chassis device.

### FIELD

The invention relates to a method and an adjustment system for keeping a vehicle on course during roll movements of a vehicle body.

### BACKGROUND

In vehicle construction, in particular in the sector of passenger vehicle construction, active chassis that offer the possibility of producing a roll movement in the curve direction, such as, for example, eABC (electromechanical active body control) or eARS (electromechanical active rolling stabilization), are being increasingly used.

The term active body control (ABC) refers, in particular, to vehicles with active suspension systems or stabilizers, the controllable chassis properties of which make possible a targeted compensation of pitch and roll movements. Usually, for this purpose, the vertical position of each wheel is electrohydraulically set. In this way, it is possible to improve the driving properties of a motor vehicle, in particular when it travels around curves, in that, for example, the motor vehicle is actively leaned into a curve.

The term electromagnetic active roll stabilization (eARS) refers to systems by way of which the suspension comfort of a vehicle can be increased, with it being possible, through active twisting of two halves of the stabilizer of the system with respect to each other, to reduce the roll of the vehicle for different roadway unevenness and in traveling around curves or cornering.

Known from DE 10 2011 010 845 B3 is a method for influencing the cornering behavior of a vehicle as well as a corresponding vehicle. In this case, a yaw response of the vehicle is compensated for by use of a front-axle/superimposed steering.

Accordingly, an active chassis of the vehicle enables a driving situation to be detected and a yaw angle to be automatically corrected.

Known from DE 10 2004 007 549 A1 is a method for operating an active chassis system in which support assemblies are arranged between the wheels and the body and in which the supporting forces of the support assemblies are adjusted by a computer. Furthermore, the wheels of at least one axle are arranged with a toe-in angle and the vertical wheel forces of the wheels of this axle take on different values due to actuation of the support assemblies, as a result of which a lateral force is produced at the axle and a resulting yaw torque is created. Accordingly, a chassis that automatically influences a yaw torque and stabilizes a driving situation of the vehicle is disclosed.

The document DE 10 2004 057 928 A1 discloses a device and a method for crosswind stabilization of a vehicle, comprising an estimating device for estimating a crosswind magnitude that reproduces the crosswind influence exerted on the vehicle and a stabilization device that is provided for influencing the lateral dynamics of the vehicle and that is supplied with the estimated crosswind magnitude for compensation of the crosswind influence exerted on the vehicle. Furthermore, the stabilization device is designed to modify the vertical wheel forces acting on the wheels of the vehicle, wherein the stabilization device modifies the vertical wheel forces depending on the crosswind magnitude in such a way that the crosswind influence exerted on the vehicle is compensated for. Accordingly disclosed is an active chassis that detects a wind load and corrects a yaw rate.

Roll movements during cornering have the drawback that they usually affect the cornering behavior of the motor vehicle. Depending on the design of the axle kinematics, a change in the camber and toe values results during curve inclinations of the vehicle owing to the compressive and rebound movements of the wheels. This leads to an undesired yaw response and side-slip angle response of the vehicle, which is uncomfortable for a driver of the vehicle and has to be compensated for by way of a steering maneuver by the driver of the vehicle.

### SUMMARY

Therefore, the object of the invention is to provide a method and an adjustment system by means of which the driving comfort for the occupants of the vehicle can be improved and by means of which a natural steering behavior of the vehicle ensues during cornering.

This object is achieved by a method having, an adjustment system that has the features of patent claim 10, and a vehicle having the features of patent claim 12.

With the use of the method according to the invention, it is possible to keep the vehicle on course. The method comprises the following method steps:

In a first step a), a lateral acceleration of the vehicle is determined. A determination of the lateral acceleration preferably is made by a measuring device, through which a current lateral acceleration can be determined.

Optionally, it is possible by use of suitable vehicle models, through calculation, and/or in the scope of a provided route preview, to determine in advance also a lateral acceleration for a point in time lying in the future. In an alternative embodiment, it is additionally possible for the lateral acceleration to be based on an estimated value.

In a following step b), a desired lateral inclination of the vehicle is established depending on the lateral acceleration that occurs during a lateral inclination and is determined in step a). The lateral inclination is understood, in particular, to mean a rotation of the vehicle around its roll axis. Such rotational movements, which are also referred to as roll, occur, in particular, during cornering of the vehicle, when lateral accelerations due to centrifugal force bring about a rotation or an inclination of the vehicle. A desired lateral inclination is preferably established in such a way that, during a rotation of the vehicle around the roll axis, an especially pleasant and mostly undisturbed driving sensation results for the occupants of the vehicle. A desired lateral inclination is optimally established, in particular, when subjectively felt lateral accelerations acting on the occupants are compensated for, at least in part.

Subsequently, in a step c), a compensatory engagement is carried out through the adjustment of at least one actuator of an active chassis device of the vehicle, so that the vehicle takes on the desired lateral inclination (a) determined in step b). The actuators of the active chassis device can be, in particular, an electrohydraulic setting device, which engages at the individual wheels of the vehicle and controls the vertical position thereof. The active chassis device can be an active suspension system, such as, for example, an active body control system and/or a system with active roll stabilizers, such as, for example, an eARS. The individual actuators of the respective wheels can be controlled, in particular, in such a way that only certain wheels are raised or lowered, so that the specified desired lateral inclination of the vehicle is adjusted. This offers the advantage that a vehicle actively inclines into a curve being traveled, as a result of which lateral accelerations that act unpleasantly on vehicle occupants can be reduced. The actively induced roll movement of the vehicle contributes to an improvement of the driving comfort feel of the vehicle occupants. In addition, any necessary counter steering maneuver on the part of the driver is reduced.

In accordance with the invention, in step d), another compensatory engagement is carried out by means of a yaw movement of the vehicle brought about by adjustment of the at least one actuator of the active chassis device. Due to the additional compensatory engagement by means of the active chassis component, an undesired yaw response and slide-slip response of the vehicle, which the driver would have to counter with an uncomfortable steering maneuver, is compensated for, because it is also possible to achieve a tracking precision of the vehicle even in the case of a roll movement during inclination at a curve. In this way, an improved method for keeping a vehicle on course is provided, because any roll movement of the vehicle is further reduced. In this way, the driving comfort is increased and the driving behavior is more secure and more agile. In particular, the customary steering behavior of the vehicle stays nearly unchanged. The compensatory engagement is preferably carried out by means of a compensatory device, which is designed as an active chassis component.

In an enhancement of the method according to the invention, the at least one additional compensatory engagement is carried out synchronously in time with step c). The compensatory engagement is hereby based on the change in the toe and camber data of the axle kinematics during a roll movement. Carrying out the compensatory engagement synchronously in time makes possible an unimpaired drive feel on the part of the vehicle occupants. In this case, the compensatory engagements of steps c) and d) can be carried out in such a way that they augment one another and, accordingly, lead to an improved drive feel.

In one embodiment of the method, the at least one additional compensatory engagement is carried out based on a compensation between a yaw rate measured using at least one sensor and a desired yaw rate specified by a driver of the vehicle and defined by the drive trajectory. Preferably, the specified yaw rate is based on a steering wheel angle and a driving speed. The deviation is calculated using a PI controller for a compensatory engagement. Through the adjustment, a compensatory engagement that is as effective as possible is achieved in that the yaw rate and, accordingly, the roll movement that is to be countered are determined.

In an alternative embodiment, the at least one additional compensatory engagement is carried out through a steering maneuver of the active superimposed steering system or through a steering maneuver of the active superimposed steering system as well as simultaneous steering engagement at a rack of an electric power steering (EPS). In this case, the superimposed steering is preferably arranged as a dynamic steering. A compensatory engagement of this kind is appropriate when the hands of a driver of the vehicle are actively placed on the steering wheel of the vehicle.

In another embodiment, the at least one additional compensatory engagement is carried out through a steering maneuver at a rack of an electrical power steering (EPS). This is advantageous when the vehicle is being guided autonomously. In this case, it is possible to achieve an additional compensatory engagement via an electric power steering. Accordingly, it is possible to use an already present vehicle component in order to keep a vehicle on course when a roll movement of a vehicle body occurs.

In another embodiment, the at least one additional compensatory engagement is carried out through a steering maneuver and/or a camber change at a twin tandem wheel bearing. This offers the advantage that an already present vehicle component can be utilized in order to keep a vehicle on course when a roll movement of a vehicle body occurs.

In an alternative enhancement of the method, the at least one additional compensatory engagement is carried out through a steering maneuver at a rear-axle steering or by means of a differential torque at the superimposed differential of the rear axle and/or of the front axle. This enhancement also offers the advantage that an already present vehicle component can be utilized in order to keep a vehicle on course when a roll movement of a vehicle body occurs.

In another embodiment, the at least one additional compensatory engagement is carried out by a differential torque with torque vectoring function at the electric motors of the rear axle and/or front axle. Due to the torque vectoring, the yaw angle or the yaw speed of a vehicle can be actively influenced. In this way, it is possible additionally to steer a vehicle via the wheels in that the drive torques are distributed differently on the left and right in a targeted manner. The effect is based on a controlled distribution of the drive torques and not on the change in the wheel position. Torque vectoring systems are electronically controlled and can supply both the faster and the slower wheel with a higher torque, so that the cornering is assisted or obstructed in a targeted manner. Accordingly, a torque vectoring system also includes the function of an electronically controlled locking differential. For the purpose of distribution, a part of the drive torque is conveyed from the differential cage directly onto the desired wheel. The interaction of torque vectoring and ESP consists in the fact that, during dynamic driving, the torque vectoring improves the stability of the vehicle so that an engagement of the ESP is postponed. By carrying out the compensatory engagement through a differential torque with torque vectoring function, it is possible for the compensation of the roll movement by an already present vehicle component to bring about an improved drive feel on the part of the vehicle occupants.

In another embodiment, the at least one additional compensatory engagement is carried out by a tensioning between the front and the rear axle due to shifting of the roll torque distribution of the active roll stabilization or of the eABC system. This offers an alternative to compensation of the roll movement of the vehicle, as a result of which a vehicle can be kept on course when a roll movement of a vehicle body occurs.

Optionally, the at least one additional compensatory engagement can be composed of a combination of at least two of the described compensatory engagements. Advantageously, the at least one additional compensatory engagement of the active chassis system is provided as a separate compensatory signal. This offers the advantage that the compensatory engagements are provided as a separate signal and are not classified by other chassis systems as a desired trajectory or desired yaw rate. Preferably, all functions are adapted in terms of their amplification via the driving speed, the steering wheel angle, or the steering wheel speed in critical driving situations, such as oversteering or understeering, or depending on the driving profile selected.

The subject of the present invention is, in addition, an adjustment system for carrying out one of the above-described methods, comprising a measuring device for determining the lateral acceleration and an actuator of an active chassis device of a vehicle.

The adjustment system according to the invention comprises at least one other active chassis component, which is designed for at least partial compensation of a yaw movement of the vehicle caused by the adjustment of the at least one actuator of the active chassis device. This offers the advantage that an already present vehicle component can be utilized in order to keep a vehicle on course when a roll movement of a vehicle body occurs.

In an advantageous enhancement of the method according to the invention, the at least one additional active chassis component is designed as an active front-axle steering, a rear-axle steering, a twin tandem wheel bearing, a superimposed differential, or an electric torque device, or as a combination thereof. Chassis components of this kind afford access to adjustment possibilities in regard to the roll movement of the vehicle. By way of a specific adjustment of chassis component in an additional compensatory engagement, a vehicle can be kept on course during a roll movement.

The subject of the present invention is, in addition, a vehicle that includes an adjustment system for carrying out the method according to the invention.

### BRIEF DESCRIPTION OF THE DRAWING

The method and the adjustment system for keeping a vehicle on course during a roll movement of a vehicle body will be illustrated schematically on the basis of implementation embodiments and will be described schematically and in detail with reference to the drawing.

FIG. 1 shows a schematic flowchart for carrying out the method for keeping a vehicle on course during a roll movement of a vehicle body.

### DETAILED DESCRIPTION

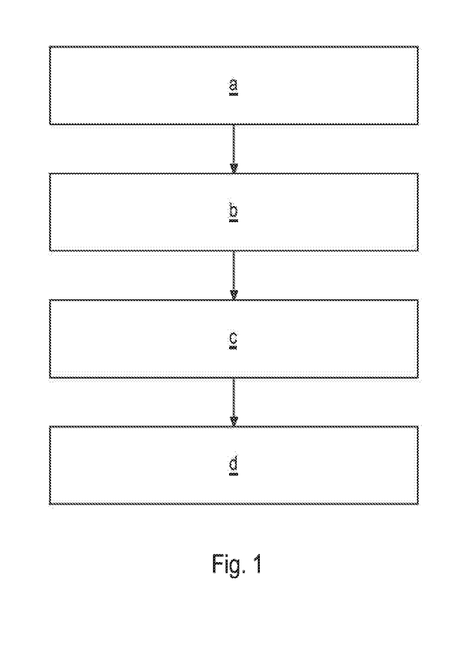

FIG. 1 shows a schematic flow chart for carrying out the method according to the invention for keeping a vehicle on course during a roll movement of a vehicle body.

In a first step a), a lateral acceleration of the vehicle is determined in this case, with this determination preferably being performed by a measuring device—not shown in FIG. 1—so that a currently prevailing lateral acceleration is determined.

In a second step b), a lateral inclination of the vehicle is established depending on the lateral acceleration established in step a). Such a lateral acceleration occurs during a lateral inclination of a vehicle. The lateral inclination is understood, in particular, to mean a rotation of the vehicle around its roll axis. Such rotational movements occur, in particular, during cornering of the vehicle, when lateral accelerations bring about a rotation or an inclination of the vehicle on account of the centrifugal force. The desired lateral inclination established in step b) is adjusted in such a way that, during a rotation of the vehicle and its roll axis, a drive feel that is as comfortable as possible and mostly undisturbeding results for the occupants of the vehicle.

In a third step c), a compensatory engagement is carried out through the adjustment of at least one actuator of an active chassis device of the vehicle, so that the vehicle carries out the desired lateral inclination determined in step b). The actuators used in step c) are preferably electrohydraulic setting devices, which engage at the individual wheels of the vehicle and control the vertical position thereof. The active chassis device can be an active suspension system, such as, for example, an active body control system, and/or a system with active roll stabilizers, such as, for example, an eARS. The individual actuators of the respective wheels can be controlled, in particular, in such a way that only specific wheels are raised or lowered, so that the specified desired lateral inclination of the vehicle is adjusted. The actively induced roll of the vehicle contributes to an improvement in the driving comfort feel of the vehicle occupants, as a result of which a necessary counter steering movement on the part of the driver can be reduced.

In accordance with the invention, in a step d) at least one additional compensatory engagement is carried out by means of a another active chassis device for at least partial compensation of a yaw movement of the vehicle caused by adjustment of the at least one actuator of the active chassis device. Carrying out step d) makes possible a tracking precision of the vehicle itself in the case of a roll movement during cornering. In this way, an undesired yaw response and slide-slip response of the vehicle, which, under certain circumstances, the driver would have to compensate with an uncomfortable steering maneuver, is counteracted. Accordingly, by way of the additional compensatory engagement, the drive feel of the vehicle occupants is improved, because the effects of any roll movement of the vehicle that are felt are further reduced. In this way, the driving comfort is increased and the driving behavior is more secure and more agile. In this case, the at least one additional compensatory engagement is based on a compensation between a yaw rate that is measured using at least one sensor and a yaw rate that is specified by a driver of the vehicle and is defined by the drive trajectory. Step d) in accordance with the invention takes place preferably synchronously in time with step c).

The compensatory engagement is preferably carried out by means of at least one additional active chassis component, which is preferably designed as an active front-axle steering, a rear-axle steering, a twin-tandem wheel bearing, a superimposed differential, or an electric torque device, or as a combination thereof.

1. A method for keeping a vehicle on course comprising the following steps:
a) determining a lateral acceleration of the vehicle:
b) establishing a desired lateral inclination of the vehicle depending on the lateral acceleration determined in step a);
c) carrying out a compensatory engagement by adjustment of at least one actuator of an active chassis device of the vehicle, so that the vehicle takes on the desired lateral inclination determined in step b),
wherein in that, d), at least one additional compensatory engagement is carried out by means of an additional active chassis device for at least partial compensation of a yaw movement of the vehicle caused by the adjustment of the at least one actuator of the active chassis device.

2. The method according to claim 1, wherein in that the at least one additional compensatory engagement is carried out synchronously in time with carrying out step c).

3. The method according to claim 1, wherein in that the at least one additional compensatory engagement is carried out based on an adjustment between a yaw rate measured using at least one sensor and a yaw rate that is specified by a driver of the vehicle and is defined by the drive trajectory.

4. The method according to claim 1, wherein in that the at least one additional compensatory engagement is carried out by way of a steering maneuver of an active superimposed steering system or by way of a steering maneuver of an active superimposed steering system and simultaneous steering operation at a rack of an electrical power steering (EPS).

5. The method according to claim 1, wherein in that the at least one additional compensatory engagement is carried out by way of a steering maneuver at a rack of an electrical power steering (EPS).

6. The method according to claim 1, wherein in that the at least one additional compensatory engagement is carried out by way of a steering maneuver and/or a camber change at a twin tandem wheel bearing.

7. The method according to claim 1, wherein in that the at least one additional compensatory engagement is carried out by way of a steering maneuver at a rear-axle steering or by means of a differential torque at the superimposed differential of a rear axle and/or front axle of the vehicle.

8. The method according to claim 1, wherein in that the at least one additional compensatory engagement is carried out by way of a differential torque with torque vectoring function or braking torque vectoring function at an electric motor of a rear axle and/or front axle of the vehicle and simultaneous increase in a drive force.

9. The method according to claim 1, wherein in that the at least one additional compensatory engagement is carried out through a tensioning between a front and a rear axle of the vehicle due to shifting a roll movement distribution of an active roll stabilization or of an eABC system.

10. An adjustment system for carrying out a method according to claim 1, comprising:
a measuring device for determination of the lateral acceleration and an actuator for carrying out a compensatory engagement of an active chassis device of a vehicle, wherein in that the adjustment system comprises at least one additional active chassis component, which is designed for at least partial compensation of a yaw movement caused by the adjustment of the at least one actuator of the active chassis device.

11. The adjustment system according to claim 10, wherein in that the at least one additional active chassis component is designed as an active front-axle steering, a rear-axle steering, a twin tandem wheel bearing, a superimposed differential, or an electric torque device, or a combination thereof.

12. The method according to claim 2, wherein in that the at least one additional compensatory engagement is carried out based on an adjustment between a yaw rate measured using at least one sensor and a yaw rate that is specified by a driver of the vehicle and is defined by the drive trajectory.

13. The method according to claim 2, wherein in that the at least one additional compensatory engagement is carried out by way of a steering maneuver of an active superimposed steering system or by way of a steering maneuver of an active superimposed steering system and simultaneous steering operation at a rack of an electrical power steering (EPS).

14. The method according to claim 3, wherein in that the at least one additional compensatory engagement is carried out by way of a steering maneuver of an active superimposed steering system or by way of a steering maneuver of an active superimposed steering system and simultaneous steering operation at a rack of an electrical power steering (EPS).

15. The method according to claim 2, wherein in that the at least one additional compensatory engagement is carried out by way of a steering maneuver at a rack of an electrical power steering (EPS).

16. The method according to claim 3, wherein in that the at least one additional compensatory engagement is carried out by way of a steering maneuver at a rack of an electrical power steering (EPS).

17. The method according to claim 2, wherein in that the at least one additional compensatory engagement is carried out by way of a steering maneuver and/or a camber change at a twin tandem wheel bearing.

18. The method according to claim 3, wherein in that the at least one additional compensatory engagement is carried out by way of a steering maneuver and/or a camber change at a twin tandem wheel bearing.

19. The method according to claim 2, wherein in that the at least one additional compensatory engagement is carried out by way of a steering maneuver at a rear-axle steering or by means of a differential torque at the superimposed differential of a rear axle and/or front axle of the vehicle.

20. The method according to claim 3, wherein in that the at least one additional compensatory engagement is carried out by way of a steering maneuver at a rear-axle steering or by means of a differential torque at the superimposed differential of a rear axle and/or front axle of the vehicle.
